(19) United States
(12) Patent Application Publication
(10) Pub. No.: US 2018/0151172 A1
(43) Pub. Date: May 31, 2018

(54) EARPHONE DEVICE HAVING NOISE CANCELLATION FUNCTION AND NOISE CANCELLATION METHOD

(71) Applicant: SORIZENPLUS CO., LTD., Ansan-si, Gyeonggi-do (KR)

(72) Inventor: Hoon MIN, Gunpo-si (TW)

(73) Assignee: SORIZENPLUS CO., LTD., Ansan-si, Gyeonggi-do (KR)

(21) Appl. No.: 15/578,238

(22) PCT Filed: Apr. 22, 2016
(86) PCT No.: PCT/KR2016/004210

§ 371 Date: Nov. 29, 2017

(30) Foreign Application Priority Data
May 29, 2015 (KR) 10-2015-0076427

(51) Int. Cl. G10K 11/178

(52) U.S. Cl. CPC G10K 11/17813; G10K 11/17853; G10K 2210/3028; G10K 2210/1081; G10K 2210/3046; G10K 2210/3056; G10K 2210/3044

(57) ABSTRACT

Provided is an earphone for eliminating the influence of external noise. The earphone comprises: a first microphone which is positioned outside an ear when the earphone is worn on the ear, so as to receive an input of a first signal that is external noise; a first processing unit for controlling the amplitude and phase of the first signal for each frequency band so as to generate an anti-phase noise cancellation signal and output the same to a speaker; a second microphone which is positioned inside an ear when the earphone is worn on the ear, so as to receive an input of a second signal that is a signal corresponding to the external noise passing through the earphone structure and introduced into the ear and an input of the antiphase noise cancellation signal output to the speaker; and a second processing unit which generates a control signal for controlling, for each frequency band, the phase and amplitude of the remaining noise signal left after a part of the second signal has been cancelled by the antiphase noise cancellation signal, such that the energy level of the remaining noise signal is minimized, and transmits the same to the first processing unit. Therefore, the present invention can achieve effective noise cancellation for not only periodic noise, but also aperiodic noise.

### TECHNICAL FIELD

The present invention relates to an earphone device having a noise removal function and a method of removing noise using the same, and more particularly, to a noise removal method in which, when noise generated from an ambient environment is input through a microphone via different routes, noises synthesized via different routes may be mutually removed, and an earphone device having a noise removal function.

### BACKGROUND ART

Techniques for outputting sound while reducing an effect of noise generated from an ambient environment have been developed. Such noise removal techniques are applied to acoustic output devices such as earphones, headphones, and the like, and aim to effectively remove noise input from the outside and minimize loss of sound essentially generated in a noise removal process.

As a conventional noise removal technique, there is a method of removing a noise signal by producing a reverse-phase noise control signal (anti-noise) having a phase with a 180° difference from that of the noise signal to be removed and the same size and combining the anti-noise with the noise signal. In this method, noise is input through a microphone installed inside an earphone or a headphone, and a reverse-phase noise control signal is generated based on this. In this case, however, a noise signal as a basic signal for generating a reverse-phase noise control signal is input from an outside of ears, and thus actually differs from noise introduced into the ears of a user by passing through an earphone instrument, and noise actually introduced into the ears via an anti-noise (reverse-phase noise removal signal) generated due to this cannot be accurately removed.

In addition, according to these conventional noise removal techniques, a reverse-phase noise control signal is produced on the basis of noise with some frequency bands from among a variety of noises due to a plurality of causes. In this case, although a specific frequency band meets requirements for removal performance of the ambient noise, a noise removal effect is reduced in other frequency bands, or, in severe cases, noise increases in another frequency band, e.g., a high frequency band of 1 kHz or more.

### DISCLOSURE

### Technical Problem

Therefore, the present invention has been made in view of the above problems, and it is one object of the present invention to provide a method of reducing an effect due to ambient noise input to an earphone.

### Technical Solution

In accordance with one aspect of the present invention, provided is an earphone including: a first microphone positioned outside an ear when the earphone is worn and receiving a first signal, the first signal being external noise; a first processor configured to generate a reverse-phase noise control signal by controlling an amplitude and phase of the first signal according to a frequency band and output the generated reverse-phase noise control signal to a speaker; a second microphone positioned inside the ear when the earphone is worn and configured to receive a second signal and the reverse-phase noise control signal output to the speaker, the second signal being a signal obtained such that the external noise passes through an earphone instrument and is introduced into the ear; and a second processor configured to generate a control signal for controlling a phase and an amplitude according to a frequency band so that an energy level of a residual noise signal remaining after the second signal is partially eliminated by the reverse-phase noise control signal has a minimum value, and to transmit the control signal to the first processor.

In accordance with another aspect of the present invention, provided is a filter bank configured to separate a first signal according to a plurality of frequency bands, the first signal being external noise input from a first microphone positioned outside an ear when an earphone is worn; and a phase control block and an amplitude control block that are configured to control a phase and amplitude of first signal components separated according to the plurality of frequency bands so that the first signal components are removed together with second signal components corresponding to the plurality of frequency bands of a second signal. In this regard, the second signal is a signal obtained such that the external noise passes from an earphone instrument through a second microphone positioned inside the ear when the earphone is worn into the ear.

In accordance with yet another aspect of the present invention, provided is a method of removing noise of an ear, including: receiving a first signal from a first microphone positioned outside an ear when the earphone is worn, the first signal being external noise; generating a reverse-phase noise control signal by controlling an amplitude and phase of the first signal according to a frequency band; receiving a second signal and a reverse-phase noise control signal, the second signal being a signal obtained such that the external noise passes from an earphone instrument through a second microphone positioned inside the ear when the earphone is worn into the ear; and generating control signals for controlling phase and amplitude according to a frequency band, on the basis of a residual noise signal remaining after the second signal is partially eliminated by the reverse-phase noise control signal.

### Advantageous Effects

According to an embodiment of the present invention, when noise generated from an ambient environment is input through a microphone via different routes, noises combined via the different routes can be mutually removed.

According to an embodiment of the present invention, noises input via different routes can be mutually removed in a wide frequency band.

### DESCRIPTION OF DRAWINGS

FIG. 1 is a view illustrating a structure of an earphone according to the present invention including microphones and speakers.

FIG. 2 is a time domain block diagram of a processing circuit for removing ambient noise from the earphone according to the present invention including microphones and speakers.

FIG. 3 is a frequency domain block diagram of a processing circuit for removing ambient noise from the earphone according to the present invention including microphones and speakers.

FIG. 4 is a detailed block diagram illustrating a detailed structure of each of a plurality of blocks of a processing circuit according to an embodiment of the present invention.

FIG. 5 is a diagram specifically illustrating a configuration of a multichannel active noise control block, according to an embodiment of the present invention.

FIG. 6 illustrates signal transmission characteristics according to frequencies of a plurality of band-pass filters in a first filter bank, according to an embodiment of the present invention.

### MODE

As the present invention allows for various changes and numerous embodiments, particular embodiments will be illustrated in the accompanying drawings and will be described in detail in the detailed description below. However, this is not intended to limit the present invention to particular modes of practice, and all changes, equivalents, and substitutes should be construed as falling within the spirit and scope of the present invention.

In the description of the present invention, certain detailed explanations of the related art are omitted when it is deemed that they may unnecessarily obscure the essence of the invention. Numbers used to describe the present specification (e.g., terms such as “first,” “second,” and the like) merely refer to reference numerals used only to distinguish one component from another.

In addition, in the present specification, it will be understood that, when an element is referred to as being “connected” to another element, the element may be directly connected to the other element, and, unless specifically stated otherwise, the element may be connected to the other element with another element present therebetween.

Hereinafter, exemplary embodiments of the present invention will be described with reference to the accompanying drawings.

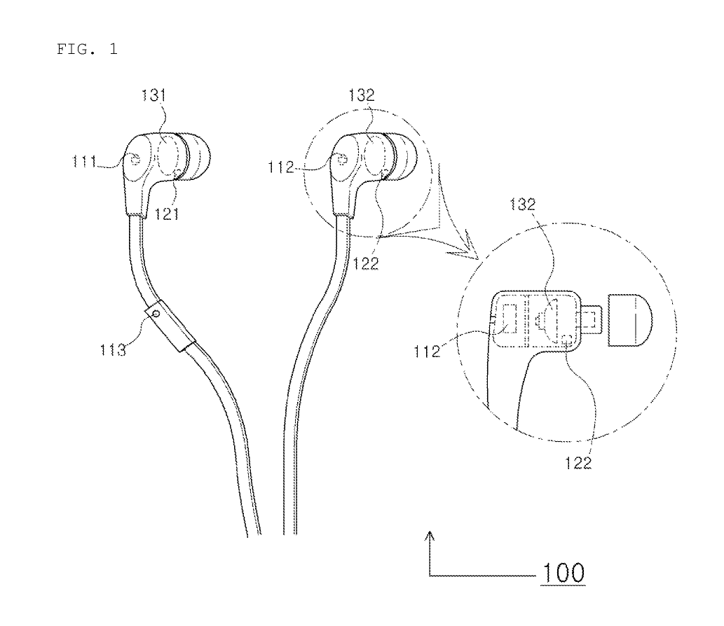

FIG. 1 is a structural view of an earphone according to an embodiment of the present invention. As illustrated in FIG. 1, the earphone 100 according to the present embodiment includes first microphones 111 and 112, second microphones 121 and 122, and speakers 131 and 132. In addition, the earphone 100 may further include a third microphone 113 to receive sound input by a user, but this is not an object to be particularly described in the present invention aiming to offset an effect due to external noise. Thus, in the present invention, only the most general earphone including the first microphones 111 and 112 and the second microphones 121 and 122 and a processing circuit installed at a certain position between the first microphones 111 and 112 and the second microphones 121 and 122 to mutually remove effects due to ambient noise will be described. Meanwhile, although FIG. 1 illustrates the earphone 100 as an insertion-type earphone, the present invention is not limited thereto. That is, the earphone 100 may also be embodied as a variety of types of earphones or headphones.

The first microphones 111 and 112 are positioned outside the ear rather than being inserted into the ear when the earphone 100 is worn, and thus exposed to the outside. As shown from an enlarged view represented by a dotted line in FIG. 1, the first microphones 111 and 112 and the speakers 131 and 132 may be positioned in spaces separated from each other by a shielding barrier. The first microphones 111 and 112 are positioned outside the ear to receive a first signal, which is external noise. The first signal is used to generate a reverse-phase noise control signal by a processing circuit, which will be described below, and the generated reverse-phase noise control signal is output to the speakers 131 and 132. The reverse-phase noise control signal output from the speakers 131 and 132 is input to the second microphones 121 and 122. A processing circuit may be installed at a certain position between the first microphones 111 and 112 and the second microphones 121 and 122 to mutually remove effects due to ambient noise.

At this time, noise input to the first microphones 111 and 112 may pass through an earphone instrument such as the shielding barrier, the speakers 131 and 132, or the like and be introduced into the ear to be input to the second microphones 121 and 122. In this case, noise input to the second microphones 121 and 122 is distorted differently from the first signal in a process of passing through the earphone instrument, or the like and introduced into the external auditory meatus, and is referred to as a distorted noise signal or a second signal.

The first signal introduced into the first microphones 111 and 112 and the second signal introduced into the second microphones 121 and 122 by being distorted in the process of passing through a variety of earphone instruments may be different from each other, and thus the second signal cannot be completely removed by a reverse-phase noise control signal generated on the basis of the first signal and, as a result, a residual noise signal remains. Hereinafter, a process of processing the residual noise signal will be described in detail with reference to the accompanying drawings.

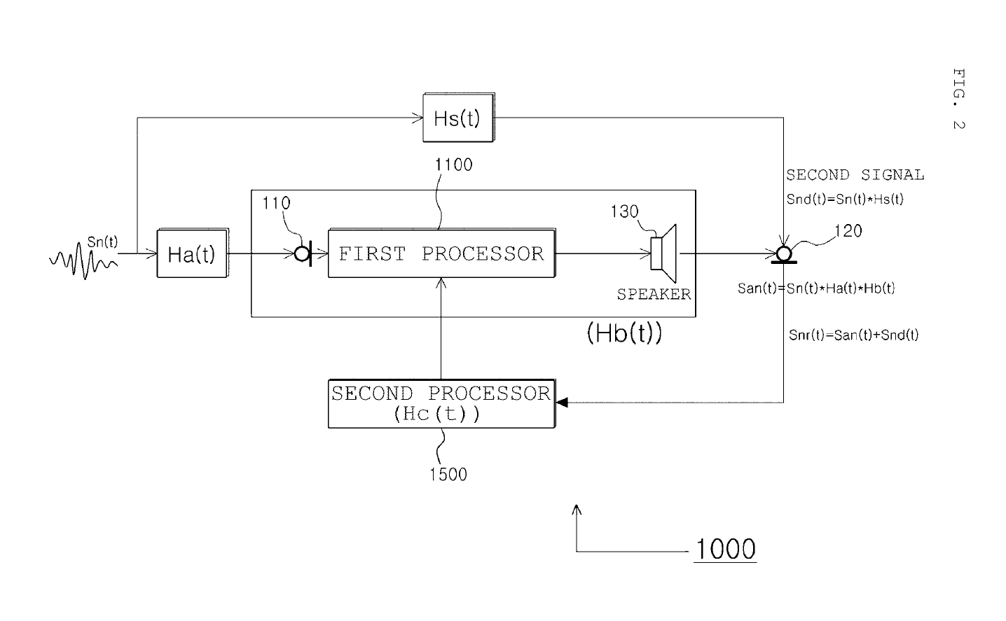

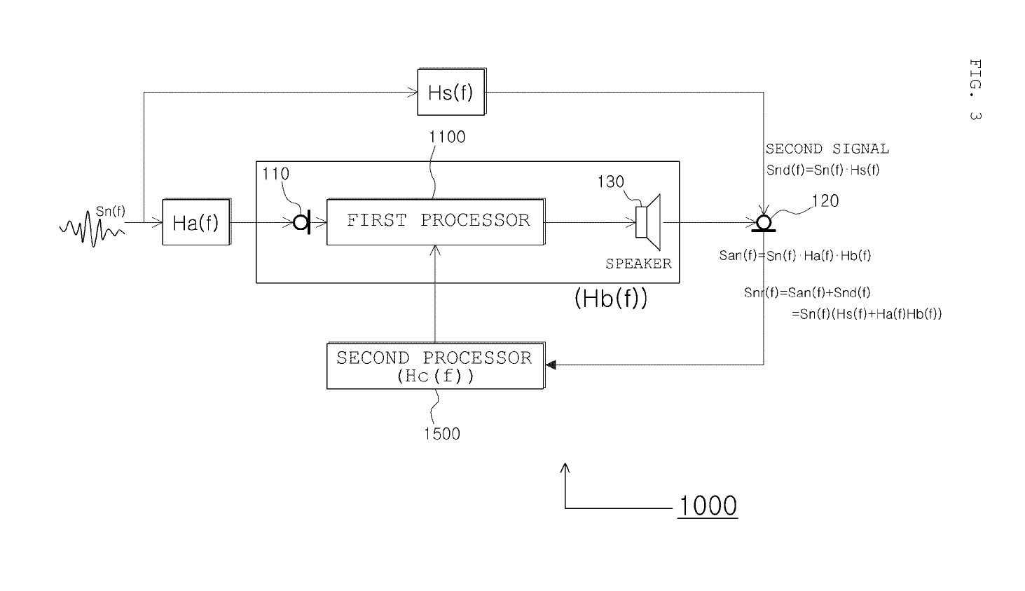

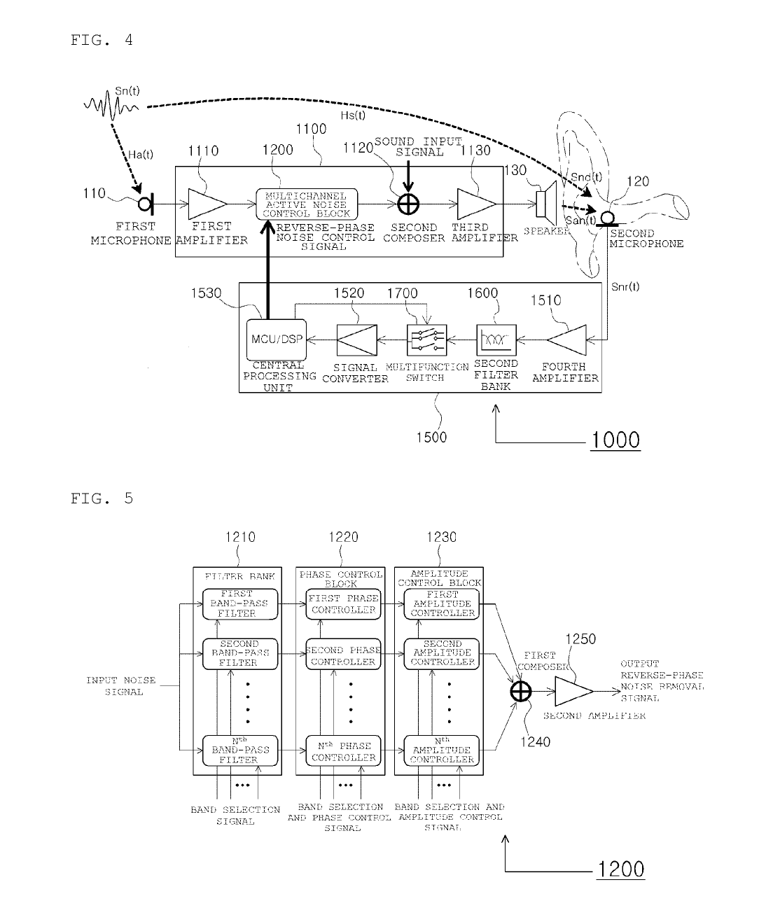

FIG. 2 is a time domain block diagram of a processing circuit for removing ambient noise from the earphone according to the present invention including microphones and speakers. FIG. 3 is a frequency domain block diagram of the processing circuit of FIG. 2. In addition, FIG. 4 is a detailed block diagram illustrating a detailed structure of each of a plurality of blocks of the processing circuit of FIGS. 2 and 3.

Referring to FIGS. 2 to 4, the processing circuit 1000 includes a first microphone 110, a second microphone 120, a speaker 130, a first processor 1100, and a second processor 1500. As illustrated in FIG. 1, the first microphone 110 may include a pair of first microphones 111 and 112, the second microphone 120 may also include a pair of second microphones 121 and 122, and the speaker 130 may also include a pair of speakers 131 and 132.

The first processor 1100 controls an amplitude and phase of a first signal, which is external noise input from the first microphone 110, according to a frequency band to generate a reverse-phase noise control signal (an anti-noise signal) and output the anti-noise signal to the speaker 130. In this regard, the first signal is calculated by Sn(t)*Ha(t), which is a time domain convolution calculation of Sn(t) and Ha(t), wherein Sn(t) is a time domain function of an external noise signal, and Ha(t) is a time domain transmission function of an external noise signal transmitted to the first microphone 110.

In this case, the reverse-phase noise control signal San(t) is given as Sn(t)*Ha(t)*Hb(t) to the first signal Sn(t)*Ha(t), assuming that a time domain transmission function of a route including the first processor 1100 and the speaker 130 is Hb(t). In addition, a second signal Snd(t), which is the distorted noise signal, is given as Sn(t)*Hs(t), assuming that a transmission function of a transmission route of external noise transmitted to the second microphone 120 via an instrument of the earphone, for example, a shielding barrier between the first microphone 110 and the speaker, or the like is Hs(t). Thus, a residual noise signal Snr(t), remaining after the reverse-phase noise control signal San(t) of the first signal and the second signal Snd(t) overlap each other in the second microphone 120, is given as San(t)+Snd(t)=(Sn(t)*Ha(t)*Hb(t))+(Sn(t)*Hs(t)).

The second processor 1500 generates a control signal according to the frequency band so that the reverse-phase noise control signal San(t) and the second signal Snd(t) are mutually removed by overlapping each other to supply the control signal to the first processor 1100. In particular, the residual noise signal Snr(t), remaining after the second signal is partially eliminated by the reverse-phase noise control signal generated by the first processor 1100, is input to the second microphone 120 to be input to the second processor 1500. The second processor 1500 generates a control signal to control phase and amplitude according to a frequency band, on the basis of the input residual noise signal and transmits the control signal to the first processor 1100. At this time, assuming that a time domain transmission function of the second processor 1500 for the residual noise signal remaining after the reverse-phase noise control signal and the second signal overlap each other is Hc(t), a reverse-phase noise control signal generated by the feedback control signal is given as Snr(t)*Hc(t)=(San(t)+Snd(t))*Hc(t)=(Sn(t)*Ha(t)*Hb(t)+Sn(t)*Hs(t))*Hc(t).

Meanwhile, FIG. 3 illustrates frequency domain conversion for the transmission functions illustrated in FIG. 2. Frequency domain interpretation of a reverse-phase noise control signal corrected on the basis of the reverse-phase noise control signal of the first signal, the second signal, and the residual noise signal provides more intuitive interpretation results than in time domain interpretation, and thus facilitates generation of a control signal in the second processor 1500.

In this regard, the reverse-phase noise control signal and the second signal are given as San(f)=Sn(f)·Ha(f)·Hb(f) and Snd(f)=Sn(f)·Hs(f), respectively. In addition, assuming that a frequency domain transmission function of the second processor 1500 is Hc(f), a reverse-phase noise control signal (an anti-noise signal) generated by the feedback control signal is given as Snr(f)·Hc(f)=(San(f)+Snd(f))·Hc(f)=(Sn(f)·Ha(f)·Hb(f)+Sn(f)·Hs(f))·Hc(f)=Sn(f)·Hc(f)·(Ha(f)·Hb(f)+Hs(f)). Thus, when a frequency domain transmission function Hb(f) of the first processor 1100 is set to be −Hs(f)·Ha(f)⁻¹ regardless of characteristics of the second processor 1500, an effect due to external noise may be fundamentally offset.

However, since an effect due to external noise by the second signal cannot be accurately identified in the first processor 1100, it is only a way to generate a reverse-phase noise control signal in consideration of an effect due to external noise by the first signal. In this case, the first signal differs from the second signal passing through an earphone instrument and being introduced into the ear (thus being actual noise heard by a user), and thus the reverse-phase noise control signal generated on the basis of the first signal cannot completely remove the second signal.

In particular, in a case in which an external noise signal is input to the first microphone 110 and the second microphone 120, the external noise as the first signal is input to the first microphone 110 via a free space, and a signal obtained as a result of distortion of the noise via an earphone instrument (e.g., an outer case of an earphone, a shielding barrier between the first microphone 110 and a speaker, a speaker, or the like), i.e., the second signal, is input to the second microphone 120. Thus, when the reverse-phase noise control signal generated by the first processor 1100 based on the first signal and output via a speaker and the second signal are input to the second microphone 120, the second signal cannot be completely removed by the reverse-phase noise control signal and, as a result, a residual noise signal remains.

The residual noise signal that cannot be completely removed is input to the second processor 1500, and, in order to minimize the input residual noise signal, the second processor 1500 adjusts a control signal to be transmitted to the first processor 1100 into a form minimizing the residual noise signal and transmits the control signal thereto.

Referring to FIG. 4, the first processor 1100 includes a multichannel active noise control block 1200. In addition, the first processor 1100 may further include a first amplifier 1110 to control amplitude in a total frequency band. As illustrated in FIG. 2, the first amplifier 1110 performs amplitude control on the total frequency band of the first signal to amplify a first signal, which is a noise signal input via the first microphone 110, to a desired signal level.

The first signal amplified by the first amplifier 1110 is input to the multichannel active noise control block 1200, and the multichannel active noise control block 1200 controls phase and amplitude according to a frequency band of the first signal input according to a control signal to be input from a central processing unit 1530 of the second processor 1500, which will be described below to generate a reverse-phase noise control signal (an anti-noise signal).

A second composer 1120 composes the reverse-phase noise control signal generated by the multichannel active noise control block 1200 and a sound signal to be output via an earphone, and the composed signal is amplified via a third amplifier 1130 to a certain signal level, and then output via the speaker 130.

In addition, according to another embodiment of the present invention, during a noise removal process of removing external noise through the present device, input of the sound signal to the second composer 110 may be prevented. That is, while a sound signal is not input, phase vales and amplitude values may be adjusted according to each of a plurality of bands to minimize external noise using an external noise removal method, and then the sound signal may be input.

The reverse-phase noise control signal San(t) output via the speaker 130 and the second signal Snd(t), which is noise introduced into the external auditory meatus from the outside of the earphone, overlap each other in the total frequency band, and the residual noise signal Snr(t) is input to the second microphone 120 and transmitted to the second processor 1500.

To feedback the residual noise signal according to such a frequency band, the second processor 1500 adaptively separates the total frequency band in consideration of the residual noise signal, generates a control signal for controlling phase and amplitude for each of the separated frequency bands, and sends a feedback thereof to the first processor 1100.

In particular, the second processor 1500 includes a fourth amplifier 1510, a second filter bank 1600, a multifunction switch 1700, a signal converter 1520, and the central processing unit 1530 (microcontroller unit (MCU)/digital signal processor (DSP)).

The fourth amplifier 1510 controls an amplitude of the residual noise signal in the total frequency band.

The second filter bank 1600 separates the residual noise signal according to a plurality of frequency bands, and has the same frequency band as that of the first filter band 1210 included in the multichannel active noise control block 1200 of the first processor 1100. According to another embodiment of the present invention, a residual noise signal amplified via the fourth amplifier 1510 may be directly input to the signal converter 1520 not via the second filter band 1600 to be converted into a digital signal.

The multifunction switch 1700 controls an on or off operation to transmit each of components of the residual noise signal separated according to the frequency band. In a state in which the total frequency band of the residual noise signal is made equal to the total frequency band and each frequency band of the external noise, when a component of the residual noise signal has a value that is less than or equal to a certain level in a specific frequency band, removal of the external noise is not needed in the specific frequency band, and thus a particular switch corresponding to the specific frequency band may be turned off.

In any embodiment, frequency bands of the first filter bank 1210 and the second filter bank 1600 must coincide with each other, and thus each of the frequency bands of the first filter bank 1210 has to be adjusted to coincide with each of the adaptively determined frequency bands of the second filter bank 1600.

The signal converter 1520 performs analog-to-digital conversion for some frequency bands corresponding to residual noise signal components transmitted by the on operation to the multifunction switch 1700.

The central processing unit 1530 generates control signals according to some frequency bands so that the first signal and the second signal are mutually removed for some frequency bands. In this regard, the control signals include a band selection signal, a phase control signal, and an amplitude control signal, which are control signals for a first filter bank, a phase control block, and an amplitude control block that constitute the multichannel active noise removal block 1200 of the first processor 1100. As described above, since the frequency bands of the first filter bank 1210 and the second filter bank 1600 coincide with each other, the band selection signal is configured to adjust each frequency band of the first filter bank 1210 to coincide with each of the adaptively determined frequency bands of the second filter bank 1600.

Hereinafter, a detailed configuration of the multichannel active noise removal block 1200 will be described.

FIG. 5 is a diagram specifically illustrating a configuration of the multichannel active noise control block 1200, according to an embodiment of the present invention. The multichannel active noise control block 1200 includes the first filter bank 1210, a phase control block 1220, an amplitude control block 1230, a first composer 1240, and a second amplifier 1250.

The first filter bank 1210 separates the first signal according to a plurality of frequency bands, on the basis of the control signals from the central processing unit 1530 of the second processor 1500. The external noise exhibits broadband characteristics due to a plurality of noise sources, and thus a value of a reverse-phase noise removal signal optimized to remove noise in a specific frequency band is not a value optimized to remove noise in another frequency band. In particular, noise increases in a high frequency band of 1 kHz or more.

Thus, the first filter bank 1210 subdivides a plurality of frequency bands and separates the first signal according to the plurality of frequency bands, on the basis of the control signals to control amplitude and phase optimized according to each frequency band. For this, the first filter bank 1210 includes first to n^{th} band-pass filters, and the first to n^{th} band-pass filters may be consecutively selected on the basis of the control signals of the central processing unit 1530.

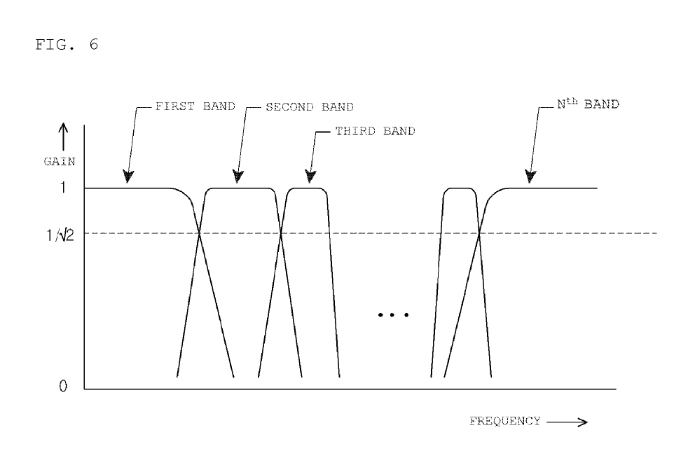

FIG. 6 illustrates signal transmission characteristics according to frequencies of a plurality of band-pass filters in a first filter bank, according to an embodiment of the present invention. According to one embodiment, the total frequency band of external noise may be divided into n bands and the first signal may be separated using a band-pass filter for each frequency band. In addition, as illustrated in FIG. 6, the total frequency band of the external noise may also be non-uniformly divided into n bands in consideration of characteristics or bandwidths (within a minimum phase shift range) of the external noise. In addition, the total frequency band of the external noise may be adaptively determined in consideration of characteristics of the external noise or processing results according to a frequency band of the first processor 1100. Among the plurality of band-pass filters, the first band-pass filter and the n^{th} band-pass filter may be embodied as a low pass filter and a high pass filter, respectively.

In addition, in a case in which the external noise is sufficiently offset at a desired level in a specific frequency band (second band-pass filter), a control signal may be selected so that the first signal passes through the second band-pass filter with respect to other frequency bands except for the second band predetermined in the second band-pass filter.

The phase control block 1220 controls phases of first signal components divided according to the plurality of frequency bands so that the first signal components are removed together with second signal components corresponding to each frequency band of the second signal.

In particular, the phase control block 1220 controls phases on the basis of a center frequency of the frequency band selected by the first filter bank 1210. First, the phase control block 1220 initializes an amplitude value of the amplitude control block, and then sets a minimum phase value for the selected frequency band. Subsequently, the phase control block 1220 stores an energy level of the residual noise signal Snr(t) input via the second microphone and sets a phase value for the selected frequency band by increasing the phase value by a certain value. Such a process is repeated until the set phase value reaches a maximum value. When the repeated process is completed, the phase control block 1220 extracts a phase value corresponding to the minimum value from among the stored energy levels and stores the extracted phase value.

When the phase control of the phase control block 1220 for the selected frequency band is completed, the amplitude control block 1230 performs amplitude control so that the first signal components are removed together with the second signal components with respect to the selected frequency band.

When the first signal components and the second signal components have the same signal size for each frequency band (the first band to the n^{th} band) and are in reverse phase (180°), the first signal and the second signal are removed together in the total frequency band, and thus removal of the external noise is enabled.

In particular, after the phase control block 1220 initializes a phase value of a phase controller corresponding to the selected frequency band to a phase value corresponding to the minimum energy level, the amplitude control block 1230 sets an amplitude value of an amplitude controller corresponding to the selected frequency band to be a minimum amplitude value. Subsequently, the amplitude control block 1230 stores an energy level of the residual noise signal Snr(t) input via the second microphone, and increases an amplitude value for the selected frequency band by a certain value to be set. Such a process is repeated until the set amplitude value reaches a maximum value. When the repeated process is completed, the amplitude control block 1230 extracts an amplitude value corresponding to a minimum value from among the stored energy levels and stores the extracted amplitude value.

This process is repeated until phase control and amplitude control for all frequency bands are completed.

Subsequently, the first composer 1240 composes the first signal components for all frequency bands on which the phase control and the amplitude control are performed through the phase control block 1220 and the amplitude control block 1230 to generate a reverse-phase noise removal signal for the total frequency band.

The second amplifier 1250 performs amplitude control on the generated reverse-phase noise removal signal in the total frequency band.

The above-described noise removal method may be performed by a controller, a processor, firmware, or the like that performs a control function in an earphone device, and may be implemented in the form of program instructions executable via a variety of computer means of the earphone device or various electronic devices connected to the earphone device and recorded in computer readable media. The computer readable media may include one selected from a program instruction, a data file, a data structure, and combinations thereof. Program instructions recorded in the media may be those specifically designed and constructed for the present invention or may be available to those skilled in the art of computer software. The hardware devices described above may be configured to operate as one or more software modules to perform the operations of the present invention, and opposite cases are also possible.

The foregoing description of the present invention is provided for illustrative purposes only, and it will be understood by those of ordinary skill in the art to which the present invention pertains that the invention may be easily modified in other particular forms without changing the technical spirit or essential characteristics of the present invention.

Thus, the embodiments described herein are provided for illustrative purposes only and not for purposes of limitation. For example, each constituent element described in a singular form may be distributed, and constituent elements described in a distributed form may also be embodied in a coupled form.

The scope of the present invention is defined by the following claims rather than the detailed description, and all changes or modified forms derived from the meaning and scope of the claims, and concepts equivalent thereto should be construed as being within the scope of the present invention.

1. An earphone comprising:
a first microphone positioned outside an ear when the earphone is worn and receiving a first signal, the first signal being external noise;
a first processor configured to generate a reverse-phase noise control signal by controlling an amplitude and phase of the first signal according to a frequency band and output the generated reverse-phase noise control signal to a speaker;
a second microphone positioned inside the ear when the earphone is worn and configured to receive a second signal and the reverse-phase noise control signal output to the speaker, the second signal being a signal obtained such that the external noise passes through an earphone instrument and is introduced into the ear; and
a second processor configured to generate a control signal for controlling a phase and an amplitude according to a frequency band so that an energy level of a residual noise signal remaining after the second signal is partially eliminated by the reverse-phase noise control signal has a minimum value, and to transmit the control signal to the first processor.

2. The earphone according to claim 1, wherein the first processor comprises a multichannel active noise control block,
wherein the multichannel active noise control block comprises:
a first filter bank configured to separate the first signal according to a plurality of frequency bands; and
a phase control block configured to control phases of first signal components separated according to the plurality of frequency bands so that the first signal components are removed together with second signal components corresponding to the frequency bands of the second signal.

3. The earphone according to claim 2, wherein the multichannel active noise control block further comprises:
an amplitude control block configured to control amplitudes of the first signal components according to the frequency bands so that the first signal components are removed together with the second signal components; and
a first composer configured to compose the first signal components having phases and amplitudes controlled by the phase control block and the amplitude control block.

4. The earphone according to claim 1, wherein the second processor further comprises:
a fourth amplifier configured to control an amplitude of the residual noise signal in a total frequency band; and
a second filter bank configured to separate the residual noise signal according to a plurality of frequency bands.

5. The earphone according to claim 4, wherein the second processor further comprises a central processing unit configured to generate control signals according to some of the frequency bands so that each of components of the residual noise signal has a minimum value with respect to the some frequency bands,
wherein the control signals comprise a band selection signal, a phase control signal, and an amplitude control signal, the control signals being control signals for the first filter bank, the phase control block, and the amplitude control block of the first processor.

6. A multichannel active noise control block comprising:
a filter bank configured to separate a first signal according to a plurality of frequency bands, the first signal being external noise input from a first microphone positioned outside an ear when an earphone is worn;
a phase control block configured to control phases of first signal components separated according to the plurality of frequency bands; and
an amplitude control block configured to control amplitudes of the first signal components separated according to the plurality of frequency bands.

7. The multichannel active noise control block according to claim 6, further comprising a first composer configured to generate a reverse-phase noise control signal by composing the first signal components having the controlled phases and amplitudes.

8. The multichannel active noise control block according to claim 6, wherein the phase control block performs a control operation by receiving a feedback of a residual noise signal remaining after a second signal and a reverse-phase noise control signal overlap each other, the second signal being external noise input via a second microphone positioned inside the ear when the earphone is worn and changing phase values so that a size of the residual noise signal has a minimum value according to the frequency bands.

9. The multichannel active noise control block according to claim 6, wherein the amplitude control block performs a control operation by receiving a feedback of a residual noise signal remaining after a second signal and a reverse-phase noise control signal overlap each other, the second signal being external noise input via the second microphone positioned inside the ear when the earphone is worn and changing amplitude values so that a size of the residual noise signal has a minimum value according to the frequency bands.

10. A method of removing noise of an earphone, the method comprising:
receiving a first signal from a first microphone positioned outside an ear when the earphone is worn, the first signal being external noise;
generating a reverse-phase noise control signal by controlling an amplitude and phase of the first signal according to a frequency band;
receiving a second signal and a reverse-phase noise control signal, the second signal being a signal obtained such that the external noise passes from an earphone instrument through a second microphone positioned inside the ear when the earphone is worn into the ear; and
generating control signals for controlling phase and amplitude according to a frequency band so that an energy level of a residual noise signal remaining after the second signal is partially eliminated by the reverse-phase noise control signal has a minimum value.
